(19) United States
(12) Patent Application Publication
(10) Pub. No.: US 2023/0189981 A1
(43) Pub. Date: Jun. 22, 2023

(54) ARTICLE FOR USE IN MOUNTING ASSOCIATED ARTICLES TO VERTICAL PLANAR MEMBERS SUCH AS FENCES

(71) Applicant: ARME Solutions, LLC, Barberton, OH (US)

(72) Inventors: Ryan McGraw, Barberton, OH (US); Erich Skelley, Coshocton, OH (US)

(21) Appl. No.: 18/169,838

(22) Filed: Feb. 15, 2023

Related U.S. Application Data
(63) Continuation-in-part of application No. 17/159,838, filed on Jan. 27, 2021, now abandoned.

(51) Int. Cl. A47B 5/00; A47B 37/04

(52) U.S. Cl. CPC A47B 5/00; A47B 37/04

(57) ABSTRACT

An article for use with an associated vertically oriented, generally planar surface may include a generally horizontal top member supported by first and second planar supporting members, which selectively receive the associated vertically oriented, generally planar associated surface therebetween.

### PRIORITY

This invention is a continuation-in-part of and claims priority to U.S. Pat. Application Number 17/159,838, filed on Jan. 27, 2021 and hereby incorporated by reference in its entirety.

### BACKGROUND

This invention generally relates to methods and apparatuses related to articles for use with fences or other generally vertically oriented planar member so that associated articles, such as flowerpots, lawn ornaments, or the like may be stored thereupon.

Many people live near, work near, or otherwise have access to planar, vertically oriented members or structures. One common generally vertically oriented planar member, and the one that is illustrated herein, is a fence, such as might be deployed around a homeowner’s yard. However, many other generally vertically oriented planar structures are in common use, such as cubicle walls in a commercial office setting, dividers in a checkout area for a commercial retail or grocery store, or a workstation in a factory. In each of these applications, the invention has applicability and use, although the discussion hereafter will be constrained to a single exemplary application of the invention, that of a fence that might surround periphery of a homeowner’s yard.

### SUMMARY

What is needed is an inexpensive, durable, and useful article which works together with the vertically oriented planar an associated structure or member to provide opportunities for the user to store useful and beautiful things. This invention will provide numerous other advantages as will be readily understood by a person of skill in the art.

An article according to the invention comprises a first supporting member which has a first interior surface. The article also has a second supporting member which has a second interior surface. The first and second supporting members are generally parallel and are configured to selectively receive therebetween an associated planar member, so that said first interior surface of said first supporting member and said second interior surface of said second supporting member are in selective operative engagement with first and second exterior surfaces of the associated generally vertically oriented planar member and thereby selectively, removably attach the article atop a top surface of the planar surface. A generally planar top member is connected to said first and second supporting members. The generally planar top member has a longitudinal centerline and a length. A plane of the associated generally vertically oriented planar member intersects said longitudinal centerline of said top member, but not bisecting said longitudinal centerline of said top member. The article further includes an opportunity location, which is at a first end of said top member and which may include a hook or an eyelet, or a battery powered or solar powered light source.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a side view of an article according to the invention.

FIG. 2 is a bottom view of the article according to the invention.

FIG. 3 is a top view of the article according to the invention.

FIG. 4 is a closeup view of the article and fastener according to the invention.

FIG. 5 is a closeup view of the article and fastener according to the invention.

FIG. 6 is a perspective view of the article mounted onto an associated generally vertically oriented planar member (or fence) fastener according to the invention.

FIG. 7 is a perspective view of the article mounted onto an associated generally vertically oriented planar member (or fence) fastener according to the invention.

FIG. 8 is a side view of the article mounted onto an associated generally vertically oriented planar member (or fence) fastener according to the invention.

FIG. 9 is a bottom view of the article mounted onto an associated generally vertically oriented planar member(or fence) fastener according to the invention.

FIG. 10 is a side view of the article mounted onto an associated generally vertically oriented planar member (or fence) fastener according to the invention.

FIG. 11 is a rear view of the article mounted onto a vertically oriented planar member (or fence) held in place by inward pressure perpendicular to top member 2.

FIG. 12 is a perspective view of the article mounted onto a planar member (or fence) with modifications to member elements.

FIG. 13A is a side view of the article as described in FIG. 1, but with adjustable fence width.

FIG. 13B is a top view of the article as described in FIG. 13A.

FIG. 14A is a side view as described in FIG. 13A with modifications to member elements.

FIG. 14B is a top view as described in FIG. 13B with modifications to member elements.

FIG. 15 is a side view of the article with modifications to member elements.

### DETAILED DESCRIPTION

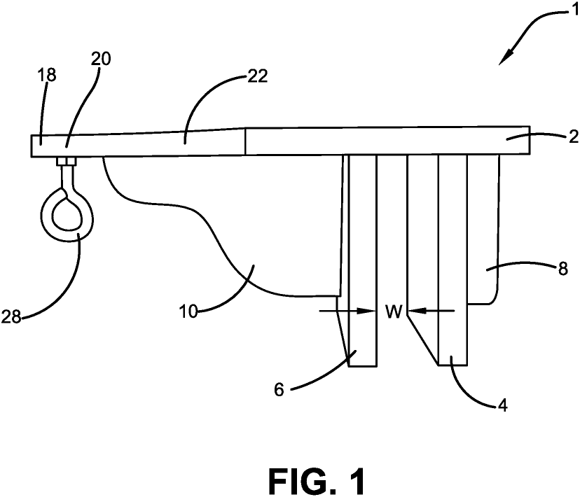

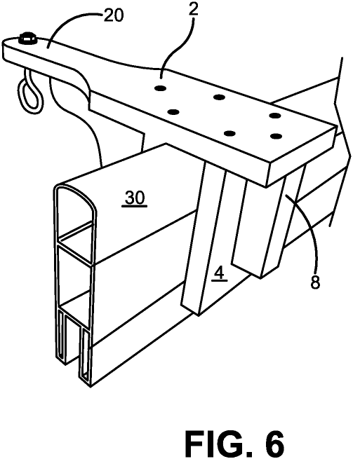

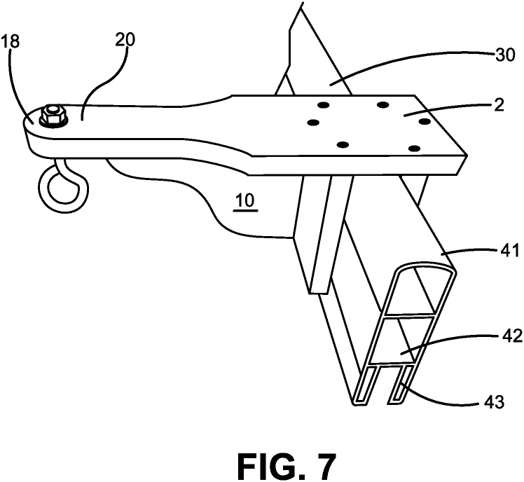

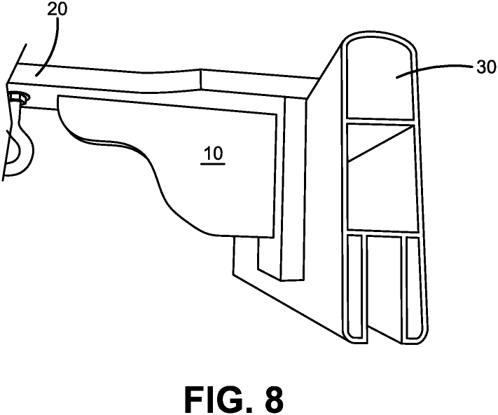

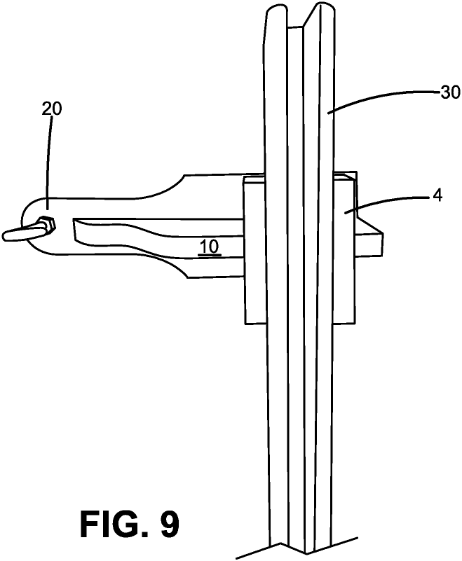

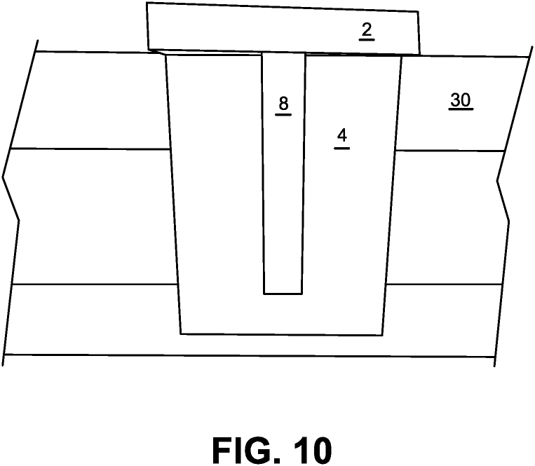

Referring now to the drawings wherein the showings are for purposes of illustrating embodiments of the invention only and not for purposes of limiting the same, and wherein like reference numerals are understood to refer to like components, FIGS. 1-15 illustrate the article as used in conjunction with an associated fence. FIG. 1 shows a side view of an article 1 according to the invention. The article 1 has a top member 2, a first supporting member 4, and a second supporting member 6. With continuing reference to FIG. 1, the article 1 also comprises a first longitudinal support member 8 and a second longitudinal support member 10.

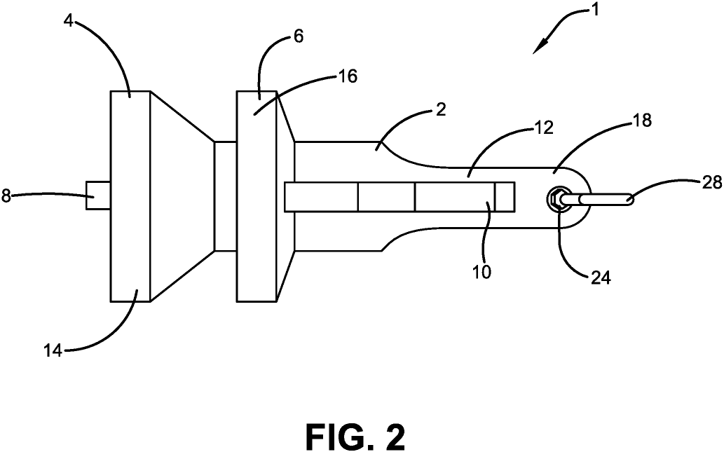

With reference to FIGS. 1 and 2, the article 1 will be further illustrated. FIG. 2 shows the underside of the article 1. For example, the underside 12 of the top member 2 is illustrated as well as a bottom surface 14 of the first supporting member 4 and a bottom surface 16 of the second supporting member 6.

With continuing reference to FIGS. 1 and 2, at a first end 18 of the top member 2 is located an opportunity location 20. The opportunity location 20 is named such because of the breadth of “opportunities” it presents. Essentially, because of the stability provided by first and second supporting members 4, 6, the top member 2 can be cantilevered into a desired space, such as a back yard, a workstation, or an office cubicle. Therefore, the top surface 20 of the top member 2 can be used to support items depending on the opportunity and need. For example, if the article 1 is used in an office setting, and the article 1 is received atop a cubicle divider, with the vertical planar surface of the vertical divider received therebetween first and second supporting members 4, 6, respectively, then the opportunity location 20 can be extended into the cubicle workspace and atop the top member 2 can be located tools (calculator, writing instruments, video camera for conferences, microphone for video conferences, etc.), if the article 1 is used in a factory setting where it is mounted upon an associated workstation divider, then tools necessary for the functions of that workstation can be located thereupon (wrenches, sealant in a tube, micrometer, ruler or measuring tape, etc.), or if the article 1 is located on a residential fence, the opportunity location 20 can be used for beautiful things such as a flowerpot, a windchime, or a handy storage space for garden tools (hand trowel, grass seed, small plants to be planted, etc.) while the article 1 is moved along the fence to wherever the homeowner is working. In a preferred embodiment, a hole 24 is drilled through the opportunity, location 20 which provides the opportunity to more permanently mount an implement. For example, one such implement might be a lamp, ideally powered by solar power or even battery so that the location along the fence may be illuminated. Another example as illustrated in FIGS. 1 and 2 is a hook or eyelet 28 which can be used to store a variety of helpful associated implements such as a hanging flower basket.

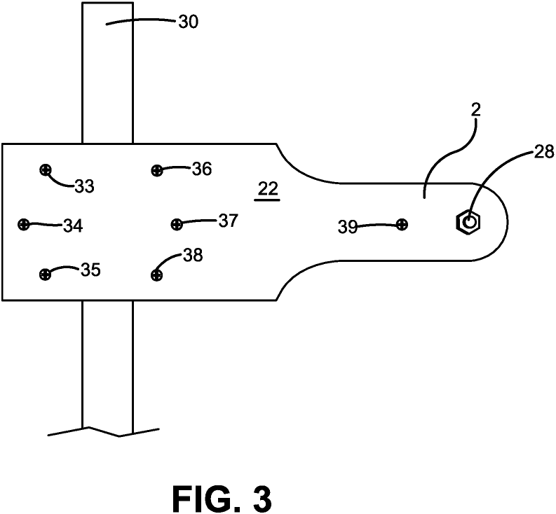

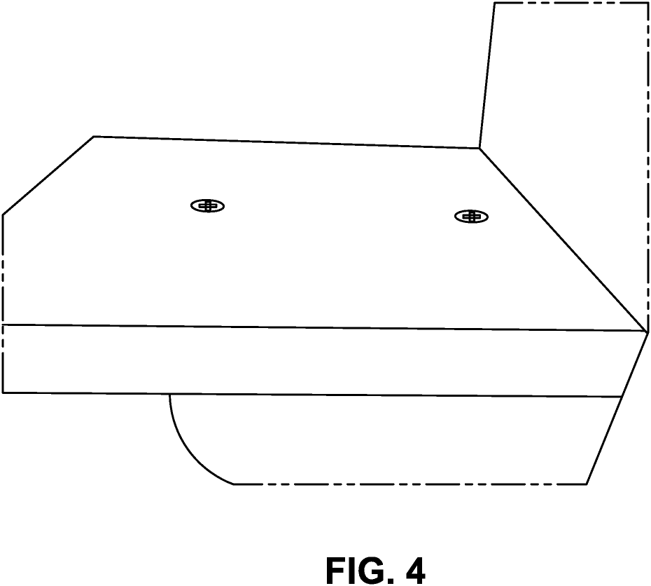

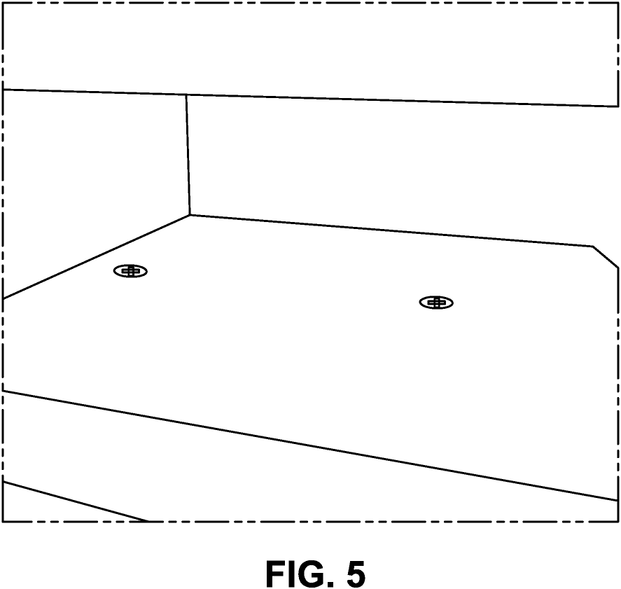

With reference to FIGS. 3-5, the manufacturing of the article 1 is illustrated. With reference to FIG. 3, the top surface 22, top member 2 is shown. Also shown in an end view of an associated vertical planar member 30. While the associated vertical planar member 30 can take a variety of forms as already discussed, for the remainder of this disclosure, the associated vertical planar member shall be referred to as a fence, although it should be understood that the associated vertical planar member should not be limited to fences. With continued reference to FIG. 3, seven different fasteners are illustrated. First fastener 33, second fastener 34, third fastener 35, fourth fastener 36, fifth fastener 37, sixth fastener 38, and seventh fastener 39 are shown in FIG. 3. In each case, the fastener is a screw which is driven through the top surface 22 of the top member 2 into other aspects of the article 1. For example, first, fastener 33 and third fastener 35 are driven into the first supporting member 4. The second fastener 34 is driven into the first longitudinal support member 8. The fourth fastener 36 and the sixth fastener 38 are driven into the second supporting member 6. The fifth fastener 37 is driven into the second longitudinal support member 10. The seventh fastener 39 is also driven into the second longitudinal support member 10. Due to the advantageous configuration of the members of the article 1 with only seven fasteners 33-39, a stable and secure article 1 is configured. FIG. 4 and FIG. 5 show additional views of the fasteners 33-39.

With reference to FIGS. 6-10, the article 1 is shown in operative engagement to an associated generally vertically oriented planar member 30, or, in the current illustration, a fence 30. In FIGS. 6-10, the associated fence 30 is shown as a plastic fence 30 made up of modular plastic members 41, 42, 43, although other fence designs will also work with the article 1.

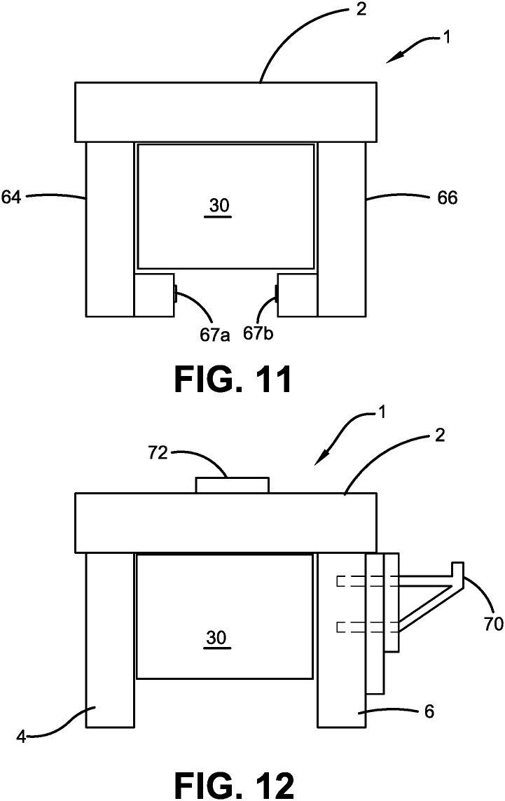

With reference to FIG. 11, the article 1 is shown in operative engagement to an associated generally vertically oriented planar member 30, or, in the current illustration, a fence 30. Top member 2 is secured by parallel support members 64, 66, the parallel support members 64, 66 having lips 67a, 67b situated on the inside of the parallel support members 64, 66, respectively, at bottom ends of the parallel support members 64, 66. The article 1 may be generally pressed down onto the fence 30 causing the parallel support members 64, 66 to separate, allowing the article 1 to mount to the fence 30. Upon the lips 67a, 67b reaching the bottom of the fence 30, the parallel support members 64, 66 may relax causing the lips 67a, 67b to move towards each other locking the article 1 in place and preventing it from dislodging from the fence 30. This configuration prevents article 1 from falling due to gravity, wind, or other forces likely to dislodge an article not thus secured.

With reference to FIG. 12, the article 1 is shown in operative engagement to an associated generally vertically oriented planar member 30, or, in the current illustration, a fence 30. The article is equipped with a solar lamp 72 secured atop top element 2 and a flag pole holder 70 secured to one of supporting members 4, 6. Thus, in this embodiment, the article 1 may serve to attach a lamp and/or a flag pole / flag to a fence. For example, it is known in the art for lighting sources to be powered by battery or by solar panels. The article 1 provides a convenient location and mechanism to support such a light. In another embodiment, a solar panel may be located on the top surface 22 of the top member 2, while the light 72 itself could be located on a bottom surface 12 of the top member 2 thereby shining its light down on a path near the fence. Or, in the case of a light which is battery powered, the battery powered light source could simply be mounted to the lower surface 12 of the top member 2. While a flag pole holder 70 secured to the first and second supporting members 4, 6 is exemplary, configurations that secure other items, including, but not limited to, torches, bird feeders, and hanging plants are also contemplated.

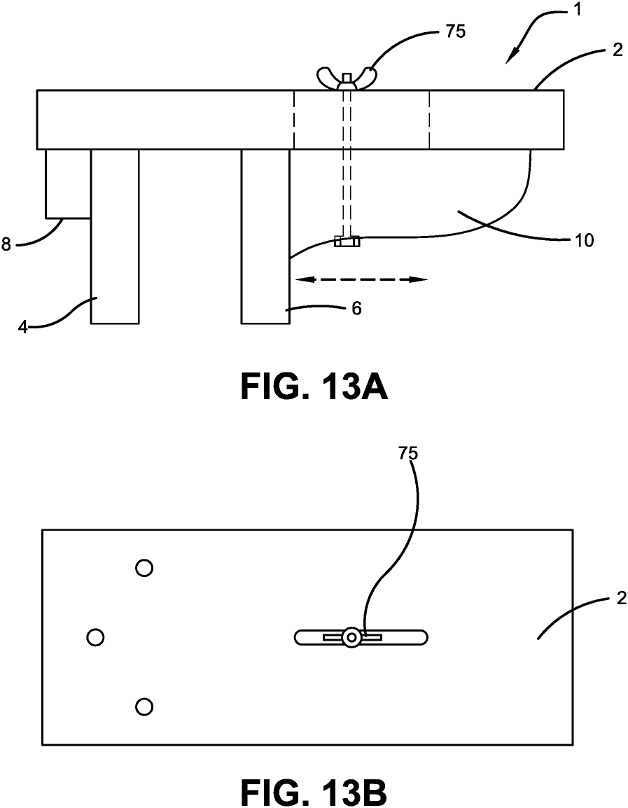

FIGS. 13A, 13B illustrate side and top views of an article 1 similar to the article 1 of FIG. 1 but including a locking feature to adjust to various widths of fence 30. The article 1 of FIGS. 13A, 13B has a top member 2, a first supporting member 4, and a second supporting member 6. The article 1 also comprises a first longitudinal support member 8 and a second longitudinal support member 10. Unlike the embodiment associated with FIG. 1, longitudinal support member 10 slides back and forth along the length of the top element 2 to adjust the gap between the support members 4, 6 to an adjustable width. Longitudinal support member 10 may slide to the appropriate position such that the gap between support members 4, 6 accommodates the width of the intended fence 30 and then secured by a securing mechanism 75. The securing mechanism 75 may be a bolt and nut combination that, once the longitudinal support member 10 is in the appropriate position such that the gap between support members 4, 6 accommodates the width of the intended fence 30, the nut may be tighten to retain the longitudinal support member 10 at the position, hence fixing the gap between support members 4, 6 to accommodate the width of the intended fence 30. Thus, in this embodiment, the article 1 may be adjusted as to clamp on to fences (or other objects) of different sizes.

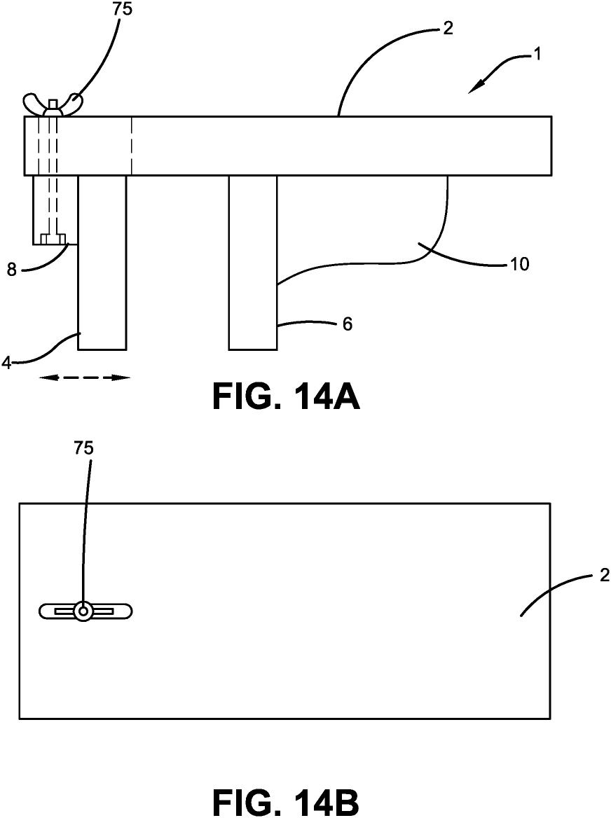

FIGS. 14A, 14B is similar to the embodiment of FIGS. 13A, 13B, except that, instead of the longitudinal support member 10 sliding, the longitudinal support member 8 slides back and forth along the length of the top element 2 to lock the gap between the support members 4, 6 to an adjustable width. Longitudinal support member 8 may slide to the appropriate position such that the gap between support members 4, 6 accommodates the width of the intended fence 30 and then secured by a securing mechanism 75. The securing mechanism 75 may be a bolt and nut combination that, once the longitudinal support member 8 is in the appropriate position such that the gap between support members 4, 6 accommodates the width of the intended fence 30, the nut may be tighten to retain the longitudinal support member 8 at the position, hence fixing the gap between support members 4, 6 to accommodate the width of the intended fence 30. Thus, in this embodiment, the article 1 may be adjusted as to clamp on to fences (or other objects) of different sizes.

With continued reference to the FIGS. 13A, 13B, 14A, 14B, it should be noted that either, neither, or both of the first and second longitudinal support members 8,10 may slide along the length of the article 1. The securing mechanism 75 which holds the first and/or second longitudinal support member 8, 10 in place may be a wing nut and bolt combination, a dowel, or any other suitable means of adjustably securing the first and/or second longitudinal support member 8, 10. The width (W) between the interior walls of the first and second supporting members 4, 6 is selectively adjustable by the supporting members 4, 6 and their corresponding longitudinal support members 8, 10 sliding along the length of the article 1 and locking in place by means of the locking mechanism 75. For example, the operator might use a fastener with a wing nut to adjust the width (W) to a desired width (for example, the width (or slightly narrower than the width) of the generally vertical planar structure 30 with which the article 1 will be used) and then secures that width by use of the fastener and wing nut.

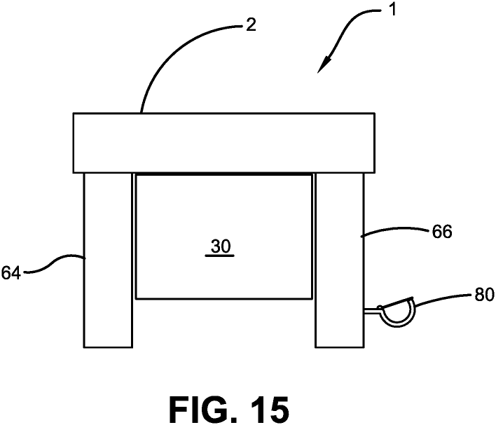

FIG. 15 shows a side view of the article 1 wherein the article 1 is shown in operative engagement to an associated generally vertically oriented planar member 30, or, in the current illustration, a fence 30. Top member 2 is secured by parallel support members 4, 6. The article also includes a hook or eyelet 80 secured to one of the parallel support members 4, 6. A user may install various articles 1 along a fence 30, each article 1 including the hook 80. In such a case, the hooks 80 may serve to hold, for example, light strings (e.g., Christmas lights), etc.

In a preferred embodiment, the article 1 will be manufactured via use of the seven fasteners 33-39, already described, and will be shipped as an assembled unit. The user may use the article 1 in a variety of ways as the variety of generally vertically oriented planar member abounds. Because the width (W) as shown in FIG. 1 is sized to fit the particular width of the associated fence or vertical planar member 30, the article 1 is simply slid onto the fence 30. No tool or sealant is generally needed. The article 1 is available for immediate use. The article 1 can be selectively attached to the fence, to a portion of the fence, or can be conveniently moved along the fence as desired. One common application is a place to store garden tools while the user works along the base of the fence 30, such as painting the fence or planting flowers or vegetation along the base of the fence 30. Another common use for the article 1 might be a drink holder or a place to store food. For example, a party host may wish to provide an article 1 for each of their guests so that the guest may place the article 1 on an associated fence to the guest’s plate of food or a beverage. In the context of a manufacturing plant where manufacturing cells are located on the manufacturing floor, it is advantageous to have tools and parts handy for the human or robotic operator, so that the parts and tools are nearby the manufactured part, speeding and facilitating the manufacturing process. The article 1 provides an opportunity for such parts or tools to be within easy reach of a human operator or robot.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof. Further, the “invention” as that term is used in this document is what is claimed in the claims of this document. The right to claim elements and/or sub-combinations that are disclosed herein as other inventions in other patent documents is hereby, unconditionally reserved.

What is claimed is:

1. An article comprising:
a first parallel support member;
a second parallel support member;
lips situated on the inside of the first and second parallel support members; and
a generally planar top member attached to said first and second parallel support members;
wherein said first and second parallel support members and said generally planar top member are arranged atop an associated generally vertically oriented planar member while the lips lock the article in place.

2. The article of claim 1, wherein a locking hook is secured to at least one of the first or second parallel support member.

3. The article of claim 1, wherein a solar lamp is secured atop the top element.

4. The article of claim 1, wherein a flagpole holder is secured to one of the first and second supporting members.

5. An article comprising:
a first supporting member;
a second supporting member;
a generally planar top member attached to said first and second supporting members,
wherein at least one of said first and second supporting members is configured to slide along said generally planar top member, thereby adjusting a gap between said first and second supporting members to conform around an associated generally vertically oriented planar member.

6. The article of claim 5, wherein a locking hook is secured to at least one of the first or second parallel support member.

7. The article of claim 5, wherein a solar lamp is secured atop the top element.

8. The article of claim 5, wherein a flagpole holder is secured to one of the first and second supporting members.

9. The article of claim 5, comprising:
a bolt passing through a) the top member and b) the at least one of said first and second supporting members or corresponding at least one longitudinal support members; and
a nut configured to tighten to the bolt to fix location of the at least one of said first and second supporting members or corresponding at least one longitudinal support members in relation to the top member.

10. An article comprising:
a first supporting member, said first supporting member having a first interior surface;
a second supporting member; said second supporting member having a second interior surface, said first and second supporting members being generally substantially parallel and arranged with a gap therebetween to receive an associated generally vertically oriented planar member;
a first longitudinal support member;
a second longitudinal support member; and
a generally planar top member attached to said first and second supporting members, said generally planar top member having a longitudinal centerline and a length,
wherein the first and second longitudinal support members may slide back and forth along the longitudinal centerline to adjust the gap between the first and second support member to securely engage the associated generally vertically oriented planar member.

11. The article of claim 10, wherein the first longitudinal support member slides and is fixed in place via a securing mechanism.

12. The article of claim 10, wherein the second longitudinal support member slides and is fixed in place via a securing mechanism.
